(19) United States
(12) Patent Application Publication
(10) Pub. No.: US 2016/0217126 A1
(43) Pub. Date: Jul. 28, 2016

(54) TEXT CLASSIFICATION USING BI-DIRECTIONAL SIMILARITY

(71) Applicant: Microsoft Technology Licensing, LLC, Redmond, WA (US)

(72) Inventors: Aadharsh Kannan, Redmond, WA (US); Kristopher Wayne Langohr, Snohomish, WA (US); Naganandhini Kohareswaran, Redmond, WA (US); Juan Balmori Labra, Redmond, WA (US)

(21) Appl. No.: 14/602,662

(22) Filed: Jan. 22, 2015

(51) Int. Cl. G06F 17/27; G06F 17/30

(52) U.S. Cl. CPC G06F 17/2715; G06F 17/30707

(57) ABSTRACT

A system for classifying text is provided. The system includes a data store containing a plurality of previously observed word sequences and a processor coupled to the data store. The processor is configured to receive a first word sequence and generate bi-directional similarity metrics based on the first word sequence and each of the previously observed word sequences. The processor is also configured to assign a classification to the first word sequence based on at least one of the bi-directional similarity metrics.

### BACKGROUND

Textual classification is used in many contexts to ascribe one or more characteristics or categories to a set of text. The set of text may simply be a word, a paragraph, or an entire document or set of documents. Automatic textual classification is highly useful in that important information can be determined automatically about the text without requiring a user to read through the text first.

Automatic textual classification, in some contexts, may employ neural networks and/or a Naïve Bayes Classifier. Regardless, typical methods generally require significant computational overhead. In instances where vast text is generated, traditional methods of text classification may be too slow and/or beyond the reasonable capacity of the device on which the classification is performed.

The discussion above is merely provided for general background information and is not intended to be used as an aid in determining the scope of the claimed subject matter.

### SUMMARY

A system for classifying text is provided. The system includes a data store containing a plurality of previously observed word sequences and a processor coupled to the data store. The processor is configured to receive a first word sequence and generate bi-directional similarity metrics based on the first word sequence and each of the previously observed word sequences. The processor is also configured to assign a classification to the first word sequence based on at least one of the bi-directional similarity metrics.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a diagrammatic view of a computing system environment in which automatic textual classification is useful.

FIG. 2 is a diagrammatic view of a computer system for performing automatic textual classification in accordance with one embodiment.

FIG. 3 is a flow diagram of a method of classifying text using a bi-directional similarity metric in accordance with one embodiment.

FIG. 4 is a diagrammatic view of a computing environment deployed in a cloud computing architecture in accordance with an embodiment.

FIG. 5 is one example of a computing system in which embodiments can be deployed.

### DETAILED DESCRIPTION

Embodiments described herein provide a highly efficient system for classifying text. Current approaches to classifying text involve either vectorizing a set of words and establishing a numerical distance between the vectors or finding metrics such as edit-distance between the set of words. The former suffers from information loss due to normalization while the latter is a non-numeric unidirectional operation that does not take into consideration the information present in both sets of words. Embodiments described below provide a bi-directional similarity metric between two sets of text or word sequences based on information in both word sequences.

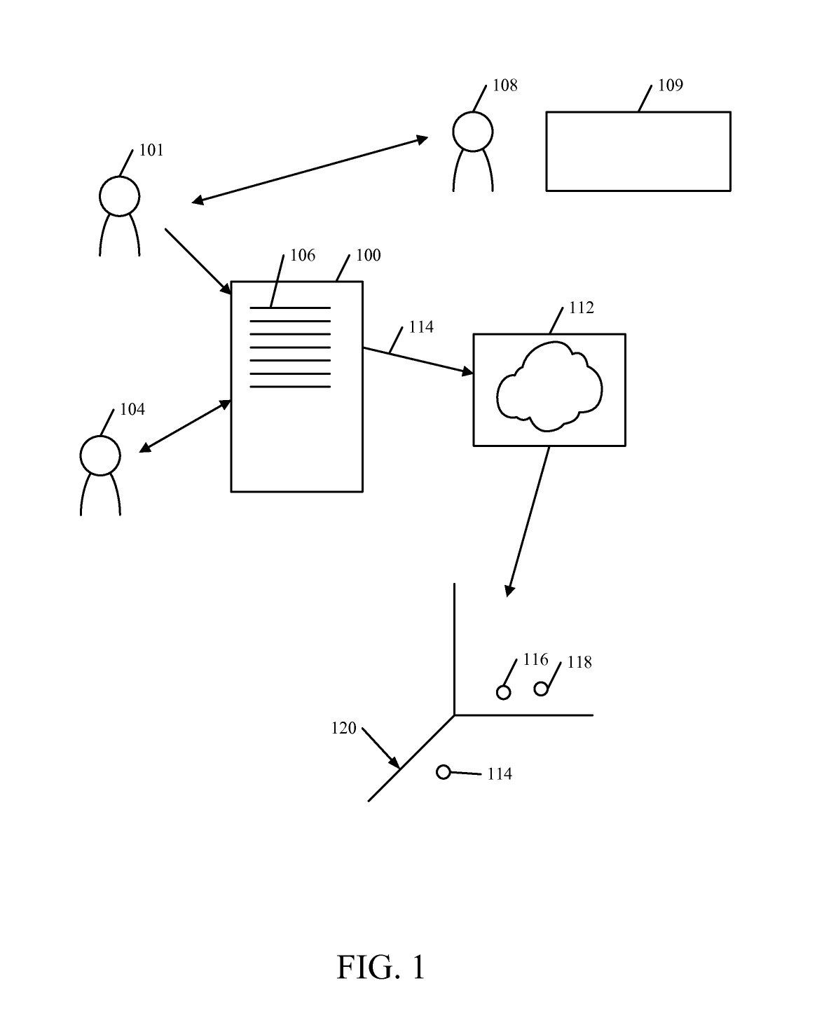

FIG. 1 is a diagrammatic view of a computing system environment in which automatic textual classification is useful. Computer system 100 may be any suitable computer system that is used by one or more users 101 either locally or remotely, via a suitable connection. Computer system 100, in some examples, includes code that is authored and/or changed by one or more developers 104, who interact with system 100. Occasionally, a change in code 106 by developer 104 will result generate an error in system 100. In order to identify and resolve the problem, user 101 may call a support center 109 or advisor 108, where advisor 108 will work with user 101 to identify various operations and contextual information about system 100 in order to resolve the problem. However, in some situations, advisor 108 may not be able to resolve the problem and will escalate the issue to an engineer. The engineer may interact with user 101 to obtain additional information; run custom tests; and/or use custom tools to identify the cause of the problem. This can be a long process that involves significant human interaction and patience.

In order to proactively identify problems before they affect users 101, a periodic analysis of all of the logs from system 100 may be performed. While such log analysis is useful in identifying potential problems before they affect users, the log analysis operation is very labor intensive. In order to facilitate the analysis of system 100 before users are affected, a listing of all exceptions and their associated exception data can be received from system 100 by exception processor 112, as indicated by arrow 114. When an error occurs, either the system or the currently executing application reports the error by throwing an exception containing information about the error. Once the exception is thrown, it is handled by the application or by a default exception handler. An exception generally includes significant information relative to the error. For example, the exception may include a text message to inform the user of the nature of the error and suggest action to resolve the problem; stack trace information; a help link; a source of the exception, as well as any additional information that may be relevant to the potential cause of the exception. Thus, exceptions can be rich collections of textual information that provide significant insight into system operation during an error.

Exception processor 112 may be a component of system 100 or may be separate therefrom. Exception processor 112 collects a list of all the exceptions that are possible and builds a hyperspace of exceptions, illustrated as points 114, 116, 118 in hyperspace 120. Then, periodically, such as daily, or in response to an event, such as the generation of a new exception, exception processor 112 will compare one or more unclassified exceptions with the known list of exceptions in order to classify the one or more unclassified exceptions. As can be appreciated, if a new exception is very similar to a previously seen exception, the new exception may be classified as related to the previously seen exception. Such similarity may allow a system engineer to assess whether remedial action appropriate for the previously seen exception may also be appropriate or at least similar to appropriate remedial action for the new exception. Conversely, if the new exception is not similar to any previously seen exceptions, then exception processor 112 can automatically escalate the exception to appropriate personnel since it may reflect an entirely new type of problem.

While embodiments described herein will be described in the context of analyzing exceptions, it should be understood that exceptions are simply one example of textual information that is amenable to the classification system and techniques described herein. Embodiments are applicable classifying any textual information and are certainly not limited to exceptions.

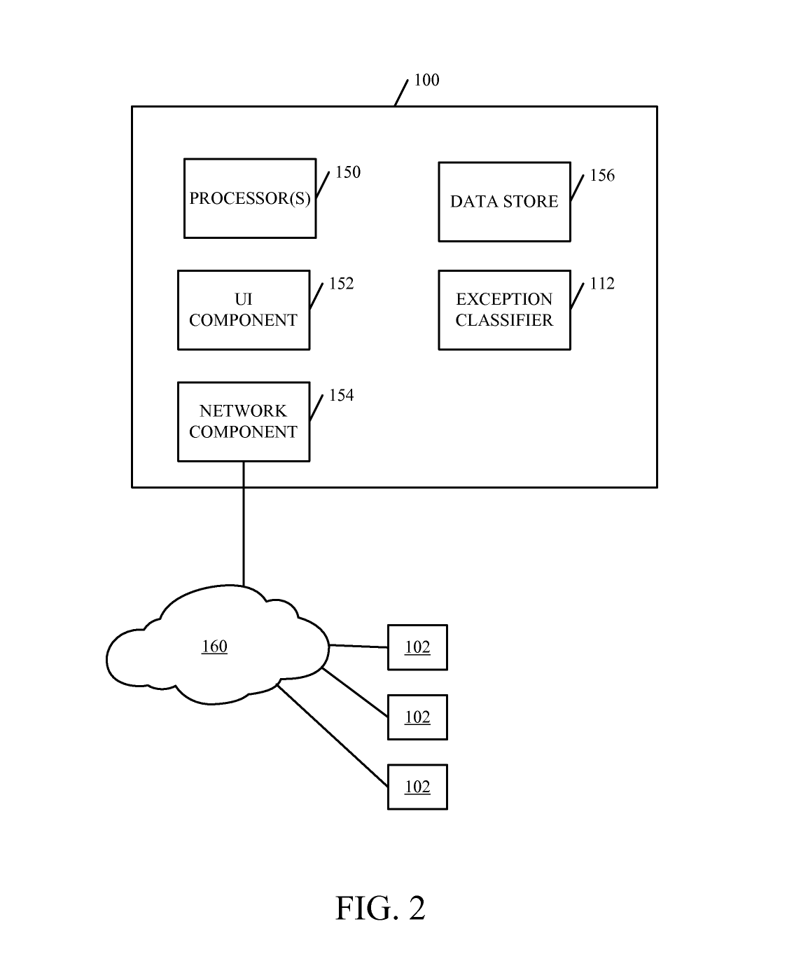

FIG. 2 is a diagrammatic view of a computer system for performing automatic textual classification in accordance with one embodiment. System 100 includes one or more processor(s) 150, user interface (UI) component 152, network component 154, data store 156 and exception classifier 112. Processor(s) 150 may be any suitable processing element that is able to load and execute instructions in order to perform a computing function. For example, processor(s) 150 may be one or more individual cores in a microprocessor. However, processor(s) 150 can also be a vast array of distributed cores working on one or more related computing tasks. As such, the generic depiction illustrated in FIG. 2 is intended to encompass a significant variety of physical implementations ranging from small embedded computing devices to entire server clusters.

UI component 152, in some examples, is able to generate or otherwise facilitate interactions with one or more users in order to allow users to interact with system 100. UI component 152 may generate one or more dialogs or user interface displays to one or more users through any suitable mechanism, such as a local display of a computing device or via a web page using a suitable data, such as HTML data.

System 100 includes or is coupled to network component 154, which allows system 100 to communicate with other devices through a suitable communication network, such as a local area network (LAN), a wide area network (WAN), such as the internet, or a combination thereof. In some examples, network component 154 may include a wired physical layer facilitating communication in accordance with the known Ethernet protocol. However, in other examples, network component 154 may include a wireless communication module(s) in addition to, or instead of, a wired physical layer. Regardless, network component 154 allows system 100 to communicate with one or more user devices 102 through network 160.

System 100 also includes or is coupled to data store 156, which may include a database or other suitable structure for storing a number of textual collections. Some of the textual collections stored within data store 156 may be training data that have already been analyzed and/or characterized. Additionally, data store 156 may include a number of textual collections (such as a log of exception data) for which classification is required.

Classifier 112 obtains a collection of text, such as an exception or other suitable grouping of text, and classifies the text by determining a bi-directional similarity metric for the collection of text as compared to one or more previously classified collections of text. Classifier 112 may also include or receive a similarity threshold such that if the similarity of the collection of text and one or more previously-classified collections of text is above the similarity threshold, then the collection of text may be assigned a classification. In one example, the collection of text includes exception information. However, embodiments are applicable to a variety of collections of text ranging from a couple of words or sentences to entire documents or collections of documents.

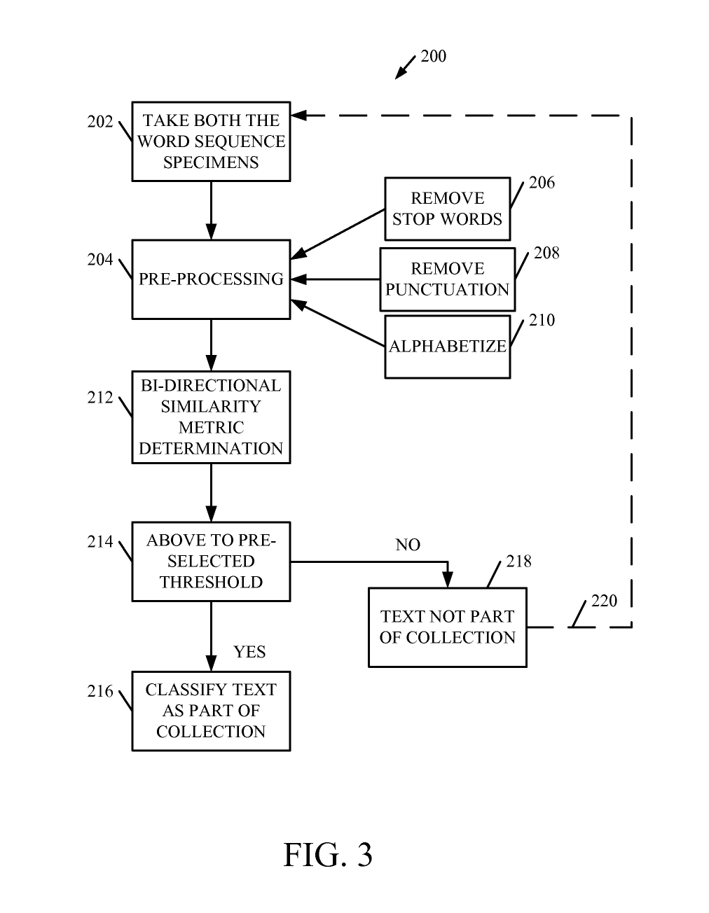

FIG. 3 is a flow diagram of a method of classifying text using a bidirectional similarity metric in accordance with one embodiment. Method 200 begins at block 202 where processor(s) 150 obtains a first word specimen or collection of text and a second word specimen or collection of previously classified text. Next, at block 204, pre-processing of one or both of the first and second word specimens is performed. In embodiments where previously classified text or word specimens are used, pre-processing the second word specimen need only be performed once. Thus, block 204, in some embodiments, may only pre-process the first word specimen. Pre-processing may include removing stop words. Stop words are a pre-defined set of words that are relatively common, yet do not appreciably add to the accuracy of classification. In one example, stop words may include words such as “on”, “which”, “the”, “at”, and “is.” This list can be tailored to the classification application as well. For example, in the context of exception classification, words or text that are common to all exceptions, for example, “exception” can be added to the list of stop words. Next, at block 208, punctuation is removed from the word specimens. In some embodiments, all punctuation is removed from the word specimens. At block 210, each of the first and second word specimens in alphabetized. Note, in some embodiments, duplicate words in a given specimen are retained such that the number of times that a given word occurs in the specimens affects the bi-directional similarity metric calculation.

At block 212, a bi-directional similarity metric is calculated between the first and second word specimens. The similarity metric is bi-directional in the sense that if the text of one specimen is fully encompassed in the second specimen, but the second specimen contains additional text not found in the first specimen, then the metric will result in less than a perfect match. Only if both specimens match each other identically, will the bi-directional similarity metric return a perfect result. In one example, the bi-directional similarity metric provides a probability that the word specimens or sequences are the same. More formally, P(Word Sequence 1 and 2 are same)=P(Word Sequence 1 is similar to Word Sequence 2)*P(Word Sequence 2 is similar to Word Sequence 1). The probability that Word Sequence 2 is similar to Word Sequence 1 is given by the total number of words in Word Sequence 2 that exist in Word Sequence 1 divided by the total number of words in Word Sequence 2. Similarly, the probability that Word Sequence 1 is similar to Word Sequence 2 is given by the total number of words in Word Sequence 1 that exist is Word Sequence 2 divided by the total number of words in Word Sequence 1. As set forth above, these two probabilities are combined, such as by multiplying them together, in order to provide the bi-directional similarity metric. However, embodiments also include applying weighting factors such that one direction is favored more than the other.

At block 214, the bi-directional similarity metric determined at block 212 is compared with a pre-defined threshold in order to determine whether to apply a classification to the first word sequence or specimen. If the bi-directional similarity metric is above the pre-defined threshold, then the classification is applied to the first word sequence, as indicated at block 216. Conversely, if the bi-directional similarity metric is not above the pre-defined threshold, then the first word sequence is not classified, and control passes to block 218, where control may return to block 202 via dashed line 220 to compare the first word sequence to another word sequence. In this way, the first word sequence will generally be classified based on its nearest neighbor in the collection.

The pre-defined threshold to cut-off classification can be learned or otherwise determined using training data and one or more binary classifiers can be trained to match a document/exception with various stack traces/word sequences. While training the classifier, the bias variance tradeoff is incorporated through the threshold value. As can be appreciated, selection of the threshold value will determine the cluster density. For example, lower thresholds will result in broader clusters while higher thresholds will result in tighter clusters.

Embodiments described herein are able to quickly utilize previously seen examples of text in order to classify new sets of text. However, embodiments can also be used to dynamically generate clusters of text. For example, a dynamic cluster can be started with a null set and will involve either the addition of a word sequence or incrementing an existing sequence's counter value depending on the threshold probability of a match between the two word sequences. As described above, a lower threshold will result is broader clusters while a higher threshold will result in tighter clusters.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, embodiments described herein may employ a variety of user interface displays. Such user interface displays may have different forms and a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted such data stores can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

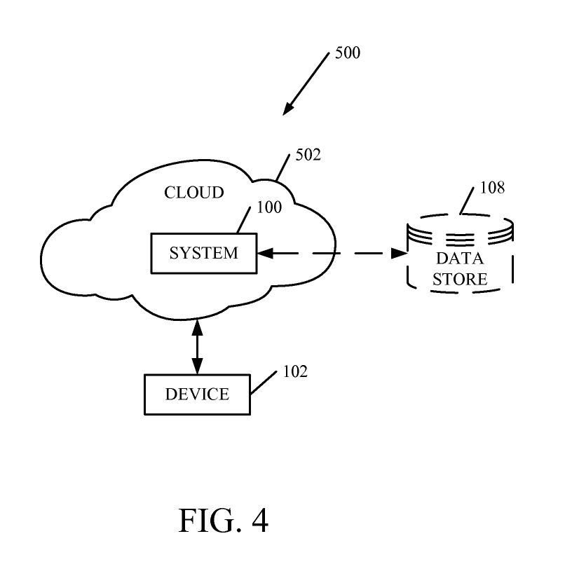

FIG. 4 is a block diagram of computing system 100, shown in FIG. 2, except that its elements are disposed in a cloud computing architecture 500. Cloud 502 is composed of at least one server computer, but may also include other interconnected devices, computers or systems. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of development environment 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 4, some items are similar to those shown in FIG. 2 and they are similarly numbered. FIG. 4 specifically shows that computing system 100 is located in cloud 502 (which can be public, private, or a combination where portions are public while others are private). FIG. 4 shows that it is also contemplated that some elements of computing system 100 are disposed in cloud 502 while others are not. By way of example, data store 108 can be disposed outside of cloud 502, and accessed through cloud 502. Regardless of where they are located, they can be accessed directly by user 102, through a network (either a wide area network or a local area network), they can be hosted at a remote site by a service, or they can be provided as a service through a cloud or accessed by a connection service that resides in the cloud. All of these architectures are contemplated herein.

It will also be noted that computing system 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, et cetera.

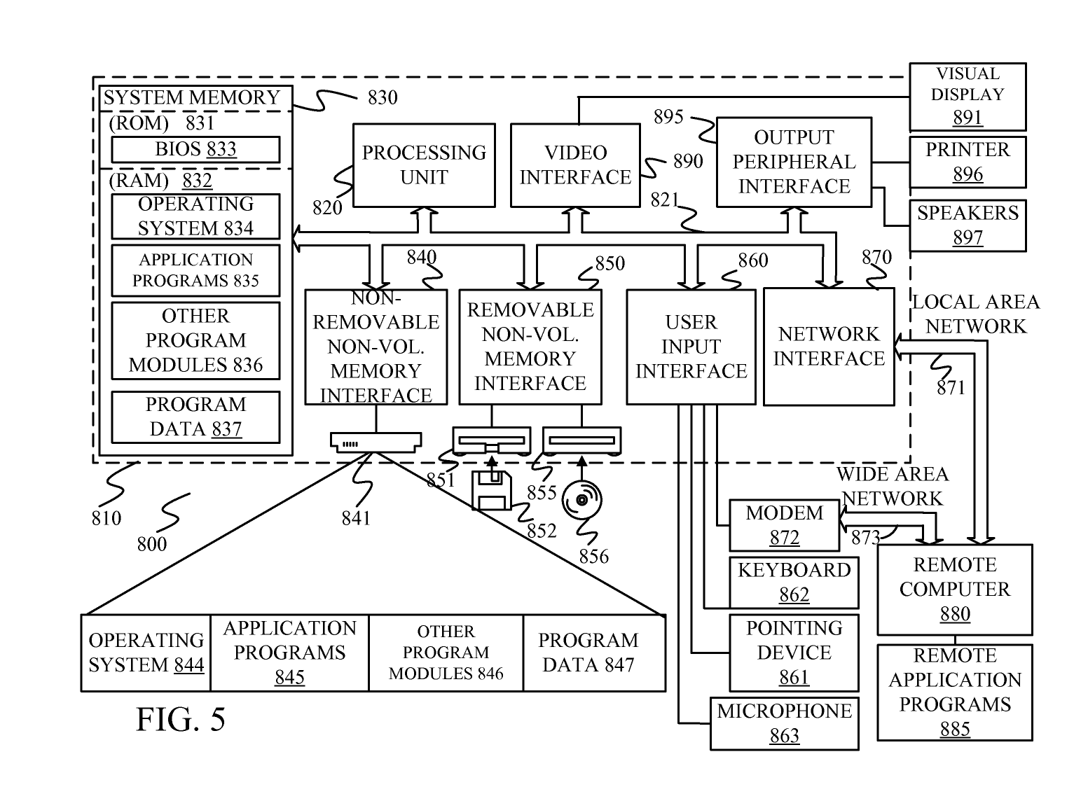

FIG. 5 is one embodiment of a computing system in which embodiments can be deployed. With reference to FIG. 5, an exemplary system for implementing some embodiments includes a computer 810. Components of computer 810 may include, but are not limited to, a processing unit 820 (which can comprise processor(s) 150), system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 5 illustrates operating system 834, application programs 835, other program modules 836, and program data 837.

The computer 810 may also include other removable/non-removable volatile/nonvolatile computer storage media. By way of example only, FIG. 5 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 5, provide storage of computer readable instructions, data structures, program modules and other data for the computer 810. In FIG. 5, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 5 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 5 illustrates remote application programs 885 as residing on remote computer 880. It will be appreciated that the network connections shown are exemplary and other means of establishing a communications link between the computers may be used.

Embodiments described herein allow a computer system to perform classification of text very quickly with relatively little computational overhead. The classification is based on a bi-directional similarity metric that employs information from both word sequences in an efficient operation. Thus, the computer is able to perform the textual classification faster than would otherwise be possible. Additionally, in embodiments where classification is performed on exception information, or other computer-generated textual information, more significant exceptions can be automatically classified and surfaced automatically for remedial action. This reduces the time required by technicians or operators to read through all of the exception information first or even at all.

It should also be noted that the different embodiments described herein can be combined in different ways. That is, parts of one or more embodiments can be combined with parts of one or more other embodiments. All of this is contemplated herein. Various examples are set forth below.

Example 1 is system for classifying text, the system includes a data store containing a plurality of previously observed word sequences and a processor coupled to the data store. The processor is configured to receive a first word sequence and generate bi-directional similarity metrics based on the first word sequence and each of the previously observed word sequences. The processor is also configured to assign a classification to the first word sequence based on at least one of the bi-directional similarity metrics.

Example 2 is a system for classifying text of any or all of the previous examples, wherein a respective bi-directional similarity metric is based on a number of words of the first word sequence that are present in a respective one of the plurality of previously observed word sequences as well as the number of words in the respective one of the plurality of previously observed word sequences that are present in the first word sequence.

Example 3 is a system for classifying text of any or all of the previous examples, wherein each respective bi-directional similarity metric is based a probability of similarity that the first word sequence is similar to a respective one of the plurality of previously observed word sequences in combination with a probability of similarity that the respective one of the plurality of previously observed word sequences is similar to the first word sequence.

Example 4 is a system for classifying text of any or all of the previous examples, wherein the probability of similarity that the first word sequence is similar to a respective one of the plurality of previously observed word sequences is based on a ratio of a total number of words of the first word sequence that are present in the respective one of the plurality of previously observed word sequences to the total number of words in the respective one of the plurality of previously observed word sequences.

Example 5 is a system for classifying text of any or all of the previous examples, wherein the probability of similarity that a respective one of the plurality of previously observed word sequences is similar to the first word sequence is based on a ratio of a total number of words of the respective one of the plurality of previously observed word sequences that are present in the first word sequence to the total number of words in the first word sequence.

Example 6 is a system for classifying text of any or all of the previous examples, wherein the bi-directional similarity metric is the product of the probability of similarity that the first word sequence is similar to a respective one of the plurality of previously observed word sequences and the probability of similarity that the respective one of the plurality of previously observed word sequences is similar to the first word sequence.

Example 7 is a system for classifying text of any or all of the previous examples, wherein the product includes equal weights for each of the probabilities.

Example 8 is a system for classifying text of any or all of the previous examples, wherein the probability of similarity that a respective one of the plurality of previously observed word sequences is similar to the first word sequence is based on a ratio of a total number of words of the respective one of the plurality of previously observed word sequences that are present in the first word sequence to the total number of words in the first word sequence.

Example 9 is a system for classifying text of any or all of the previous examples, wherein the processor is configured to perform pre-processing of the first word sequence before determining the bi-directional similarity metrics.

Example 10 is a system for classifying text of any or all of the previous examples, wherein the pre-processing includes removing stop words.

Example 11 is a system for classifying text of any or all of the previous examples, wherein pre-processing includes maintaining multiple occurrences of the same word.

Example 12 is a system for classifying text of any or all of the previous examples, wherein pre-processing includes alphabetizing the first word sequence.

Example 13 is a system for classifying text of any or all of the previous examples, wherein the plurality of previously observed word sequences are pre-processed.

Example 14 is a system for classifying text of any or all of the previous examples, wherein the first word sequence is computer-generated.

Example 15 is a system for classifying text of any or all of the previous examples, wherein the computer-generated first word sequence includes exception information.

Example 16 is a system for classifying text of any or all of the previous examples, wherein the processor is configured to selectively apply the classification if at least one of the bi-directional similarity metrics exceeds a pre-defined threshold.

Example 17 is a computer-implemented method for classifying computer-generated text. The method includes pre-processing the computer-generated text and at least one previously observed exception. A first probability of similarity of the computer-generated text to the at least one previously observed exception is determined. A second probability of similarity of the at least one previously observed exception to the computer-generated text is determined. A bi-directional similarity metric is generated based on the first and second probabilities. The computer-generated text is selectively classified if the bi-directional similarity metric exceeds a pre-defined threshold.

Example 18 is a computer-implemented method of any or all of the previous examples wherein the computer-generated text is exception information.

Example 19 is a computer-implemented method of comparing a first set of text to a second set of text. The method includes determining a first probability of similarity of the first set of text to the second set of text and determining a second probability of similarity of the second set of text to the first set of text. A bi-directional similarity metric is generated based on the first and second probabilities. The first set of text is classified based on the bi-directional similarity metric and the second set of text.

Example 20 is a computer-implemented method of any or all of the previous examples wherein the first probability is based on a total number of words in the first set of text that are present in the second set of text divided by the total number of words in the first set of text; and the second probability is based on a total number of words in the second set of text that are present in the first set of text divided by the total number of words in the second set of text.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system for classifying text, the system comprising:
a data store containing a plurality of previously observed word sequences;
a processor coupled to the data store and configured to receive a first word sequence and generate bi-directional similarity metrics based on the first word sequence and each of the previously observed word sequences; and
wherein the processor is configured to assign a classification to the first word sequence based on at least one of the bi-directional similarity metrics.

2. The system of claim 1, wherein a respective bi-directional similarity metric is based on a number of words of the first word sequence that are present in a respective one of the plurality of previously observed word sequences as well as the number of words in the respective one of the plurality of previously observed word sequences that are present in the first word sequence.

3. The system of claim 1, wherein each respective bi-directional similarity metric is based a probability of similarity that the first word sequence is similar to a respective one of the plurality of previously observed word sequences in combination with a probability of similarity that the respective one of the plurality of previously observed word sequences is similar to the first word sequence.

4. The system of claim 3, wherein the probability of similarity that the first word sequence is similar to a respective one of the plurality of previously observed word sequences is based on a ratio of a total number of words of the first word sequence that are present in the respective one of the plurality of previously observed word sequences to the total number of words in the respective one of the plurality of previously observed word sequences.

5. The system of claim 4, wherein the probability of similarity that a respective one of the plurality of previously observed word sequences is similar to the first word sequence is based on a ratio of a total number of words of the respective one of the plurality of previously observed word sequences that are present in the first word sequence to the total number of words in the first word sequence.

6. The system of claim 3, wherein the bi-directional similarity metric is the product of the probability of similarity that the first word sequence is similar to a respective one of the plurality of previously observed word sequences and the probability of similarity that the respective one of the plurality of previously observed word sequences is similar to the first word sequence.

7. The system of claim 6, wherein the product includes equal weights for each of the probabilities.

8. The system of claim 3, wherein the probability of similarity that a respective one of the plurality of previously observed word sequences is similar to the first word sequence is based on a ratio of a total number of words of the respective one of the plurality of previously observed word sequences that are present in the first word sequence to the total number of words in the first word sequence.

9. The system of claim 1, wherein the processor is configured to perform pre-processing of the first word sequence before determining the bi-directional similarity metrics.

10. The system of claim 9, wherein the pre-processing includes removing stop words.

11. The system of claim 9, wherein pre-processing includes maintaining multiple occurrences of the same word.

12. The system of claim 9, wherein pre-processing includes alphabetizing the first word sequence.

13. The system of claim 9, wherein the plurality of previously observed word sequences are pre-processed.

14. The system of claim 1, wherein the first word sequence is computer-generated.

15. The system of claim 14, wherein the computer-generated first word sequence includes exception information.

16. The system of claim 1, wherein the processor is configured to selectively apply the classification if at least one of the bi-directional similarity metrics exceeds a pre-defined threshold.

17. A computer-implemented method for classifying computer-generated text, the method comprising:
pre-processing the computer-generated text and at least one previously observed exception;
determining a first probability of similarity of the computer-generated text to the at least one previously observed exception;
determining a second probability of similarity of the at least one previously observed exception to the computer-generated text; and
generating a bi-directional similarity metric based on the first and second probabilities; and
selectively classifying the computer-generated text if the bi-directional similarity metric exceeds a pre-defined threshold.

18. The computer-implemented method of claim 17, wherein the computer-generated text is exception information.

19. A computer-implemented method of comparing a first set of text to a second set of text, the method comprising:
determining a first probability of similarity of the first set of text to the second set of text;
determining a second probability of similarity of the second set of text to the first set of text; and
generating a bi-directional similarity metric based on the first and second probabilities; and
classifying the first set of text based on the bi-directional similarity metric and the second set of text.

20. The computer-implemented method of claim 19, wherein:
the first probability is based on a total number of words in the first set of text that are present in the second set of text divided by the total number of words in the first set of text; and
the second probability is based on a total number of words in the second set of text that are present in the first set of text divided by the total number of words in the second set of text.
